(19) United States
(12) Patent Application Publication
(10) Pub. No.: US 2003/0050888 A1
(43) Pub. Date: Mar. 13, 2003

(54) Real-time computerized stock trading system

(76) Inventors: Michael Satow, New York, NY (US); Eugene Choe, Cliffside Park, NJ (US); Michael Hermus, New York, NY (US); Stanley Leong, Bayside, NY (US)

Correspondence Address: FINNEGAN, HENDERSON, FARABOW, GARRETT &, DUNNER LLP, 1300 I STREET, NW, WASHINGTON, DC, 20006, US

(21) Appl. No.: 10/223,091

(22) Filed: Aug. 19, 2002

Related U.S. Application Data
(62) Division of application No. 09/376,346, filed on Aug. 18, 1999.
(60) Provisional application No. 60/097,414, filed on Aug. 21, 1998.

(51) Int. Cl. G06F 17/60

(52) U.S. Cl. 705/37

(57) ABSTRACT

A method and system provide real-time, after-hours stock trading to both retail and institutional investors. The system acts as a hub connecting investors from numerous brokerage firms and delivers real-time, after-hours trading services to both retail and institutional investors. It matches buy and sell trade orders placed by different investors on the system, thereby allowing both retail and institutional investors to execute trades with each other either before, during or after-hours. Consistent with the present invention, when the trading system's matching engine determines that a buy order and a sell order from different investors match, it executes and processes the trade. In one implementation, the system's market information is published in real-time on the Internet and is viewable by investors and the general public.

### RELATED APPLICATIONS

This patent application claims priority to Provisional U.S. Patent Application No. 60/097,414, entitled “Online Trading System” and filed on Aug. 21, 1998, which is herein incorporated by reference.

The following identified U.S. patent applications are relied upon and are incorporated in their entirety by reference in this application.

U.S. patent application Ser. No. ______, entitled “Anti-Manipulation Method and System for a Real-Time Computerized Stock Trading System” bearing attorney docket no. 07444.0012, and filed on the same date herewith.

U.S. patent application Ser. No. ______, entitled “Volume Limitation Method and system for a Real-Time Computerized Stock Trading System” bearing attorney docket no. 07444.0013, and filed on the same date herewith.

### BACKGROUND

The present invention relates generally to stock trading and, more particularly, to a real-time, computerized stock trading system.

Financial markets are growing technologically and also becoming increasingly global.

As a result, many new investment opportunities are emerging in the marketplace, especially after the stock markets close. Although professional, institutional investors have long traded securities after-hours, non-professional retail investors, typically individuals, have been effectively excluded from the after-hours trading market. Consequently, many of these retail investors desire equal access and opportunity.

Traditional brokerage firms, whose control over vital information made them the market's gatekeepers, are changing their approach, and their fees. Meanwhile, more investors everyday continue to open accounts with “on-line” brokerage firms, which allow individuals to enter orders and view account information over the Internet. Today, there are many brokerage firms which offer online trading. Retail investors conventionally use the brokerage firms to place trade orders that executed during the day when the financial markets are open. Frequently however, investors place orders online after the markets close, but these trades are not executed until the daytime stock exchanges are open.

The existing day-time market infrastructure is not fully automated, which makes it difficult to provide individuals with direct access to market information or extend the hours of operation. While several companies operate electronic automated trading systems that operate during and after market hours, these firms limit participation on their systems to institutions, excluding the retail investor from taking advantage of investment opportunities after markets close. One such system is Reuters' Instinet, the leading computerized institutional trading system, and although Instinet operates both during and after market hours, it is designed for use by institutions.

Some other conventional electronic trading systems, such as ITG's POSIT, do not operate in real-time and use static matching engines that periodically match investors' orders as a batch process. The lack of real-time processing prohibits immediate interactive trading and prevents investors from reacting to immediate price changes and instantaneously seeing other orders placed.

Additionally, conventional systems do not make information on real-time, after-hours trading activity publicly available to individuals. This lack of real-time publishing prevents after-hours retail investors and the general public from seeing immediate changes in trading opportunities they occur.

### SUMMARY OF THE INVENTION

In accordance with the present invention, an automated method for trading stocks receives a first trade order from a first non-institutional user outside of exchange trading hours and receives a second trade order from a second non-institutional user outside of exchange trading hours. It matches the first trade order with the second trade order and executes a trade in real-time between the first and second users when a match is determined between the first trade order and the second trade order.

In accordance with another aspect of the present invention, an automated method for publishing real-time stock trading information from a computerized stock trading system is provided. The stock trading information includes open trade order information regarding open trade orders that have not been matched in the trading system. The method comprises the steps of accessing a trading system database to retrieve the open trade order information of trades placed by non-institutional users to be executed in real-time outside of exchange trading hours, and retrieving the open trade order information from the trading system database. Furthermore, it sends the open order information over the Internet to a user.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 illustrates a block diagram of a real-time computerized trading system in accordance with the present invention;

FIG. 2 displays a flowchart illustrating the steps of a method for placing a trade order in the trading system in accordance with the present invention;

FIGS. 3A, 3B and 3C depict exemplary broker-dealer order entry screens in accordance with the present invention;

FIG. 4 illustrates the steps of a method for matching a trade order in the trading system in accordance with the present invention;

FIG. 5 depicts the steps of the method for publishing the trading system market information over a network, such as the Internet, in accordance with the present invention; and

FIG. 6 shows a market information mechanism in accordance with the present invention.

### DETAILED DESCRIPTION

Methods and systems consistent with the present invention provide real-time, after-hours computerized stock trading to both retail and institutional investors. One system consistent with the present invention acts as a hub connecting investors from numerous brokerage firms and effectively delivers real-time, after-hours trading services to both retail and institutional investors. It matches buy and sell trade orders placed by different investors on the system, thereby allowing both retail and institutional investors to execute trades with each other either during or after-hours. Another system consistent with the present invention publishes the trading information in real-time, for example, over the Internet. The increased access provides opportunities for retail investors to execute stock trade orders after the close of the conventional day-time financial markets, and the real-time aspect allows investors to continuously react to immediate changes in stock prices. It should be noted that after-hours refers to any time outside of exchange trading hours, i.e., any time the primary securities exchanges such as the New York Stock Exchange and the American Stock Exchange do not accept for immediate execution purchase or sale orders for securities, including before the exchanges open.

An on-line, real-time, computerized trading system consistent with the present invention is connected to brokerage firms for the benefit of both their institutional and retail clients.

Investors place trade orders through their retail brokerage firms, which then relay the orders on a private network to the system's matching engine for immediate execution either during or after-hours. Retail investors primarily access the system through their brokerage firm's existing online trading systems by entering trade orders on their personal computers. Offline investors can place trade orders with their registered representatives who will then submit the orders on their behalf to the trading system for execution. Professional traders can access the system through professional trading software specifically intended for use by these types of investors. By filtering trades through the brokerage firms, the brokerage firms' computer systems ensure that the accounts contain necessary buying or selling power for the transactions, and the trading system utilizes the existing security measures already implemented by the brokerage firms. As such, the investors need not have separate accounts because they may use their existing brokerage accounts. However, the user does not necessarily have to connect to the system through a brokerage firm, and the connection may be directly to the trading system or by other means.

When the trading system's matching engine determines that a buy order and a sell order from different investors match, it executes and processes the trade. Information about open orders can be sent via web server to the Internet and can be viewed by investors and the general public in real-time.

The system may also have anti-manipulation mechanisms so that investors may not manipulate the trading system's market with schemes such as self-trading or round-robin trading as described in co-pending U.S. patent application Ser. No. ______. Furthermore, it may contain other protective mechanisms such as volume limitations to limit institutional influence within the market as described in co-pending U.S. patent application Ser. No. ______. The trading system may have other mechanisms, both protective and otherwise, not specifically mentioned here.

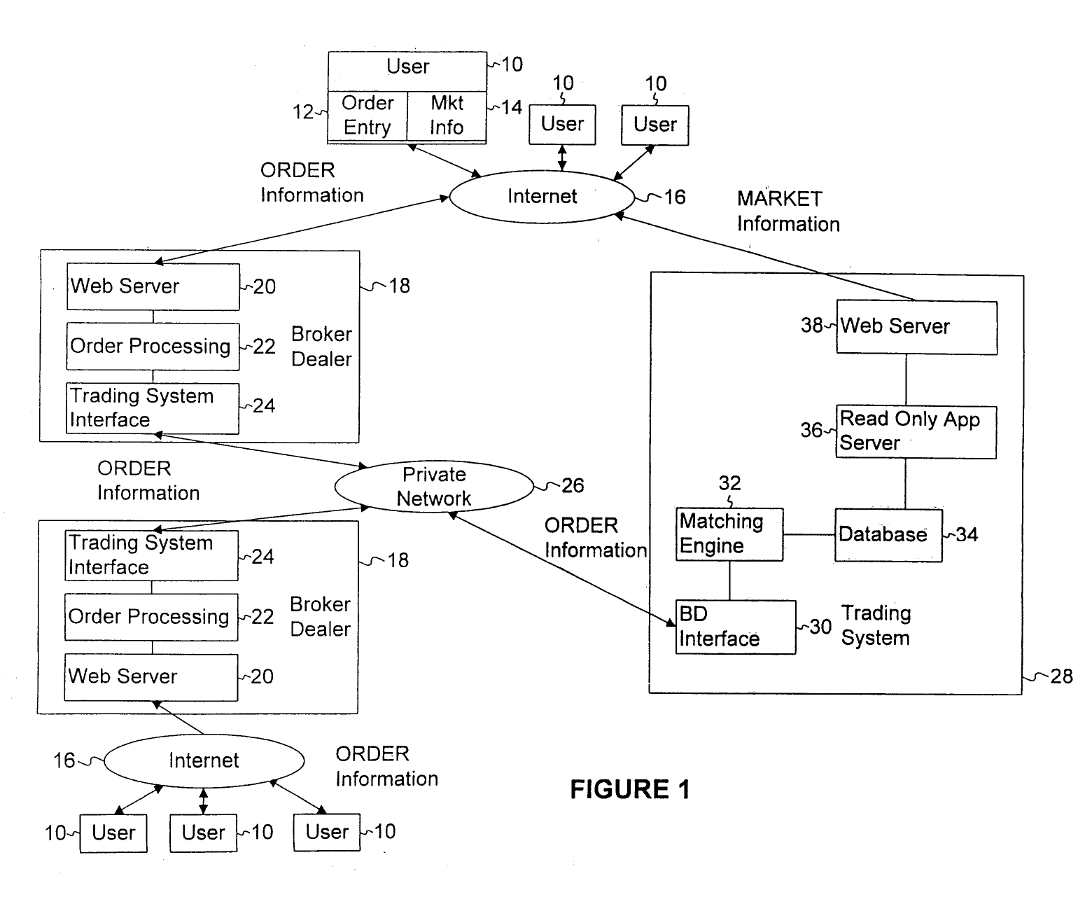

FIG. 1 illustrates a block diagram of an exemplary proprietary, real-time, computerized trading system consistent with the present invention. Retail or institutional investors, referred to as users 10, may access the trading system 28 directly through their personal computers using the existing online trading networks of their brokerage firms, referred to as broker-dealers 18 (“BD”). Online investors' trades may be filtered through their broker-dealers' computer systems, as they currently are, to ensure that the investor's accounts contain necessary buying power and meet requirements imposed by the broker-dealers 18 for the transactions they wish to conduct on the system. Additionally, users 10 may also be broker-dealers 18.

The computer systems used by users 10, broker-dealers 18, and the trading system 28 may be general-purpose computers that run the necessary software and contain the necessary hardware components for implementing methods consistent with the present invention. These computer systems may also have additional components not shown on FIG. 1. Furthermore, although two broker-dealers 18 and six users 10 are shown on the figure, any number of broker-dealers 18 and users 10 may use the trading system 28 in accordance with the present invention.

The various software components of a system consistent with the present invention may be programmed in a programming language such as the Java™ programming language, which is further described in “The Java Programming Language,” 2^{nd} Ed., Ken Arnold, James Gosling, Addison-Wesley, 1998, which is incorporated herein by reference. For further description of the Java Lanauaue, refer to “The Java Language Specification,” James Gosling, Bill Joy, Guy Steele, Addison-Wesley, 1996 which is also incorporated herein by reference. When programmed in the Java programming language, the source code for the software is portable across multiple operating systems (i.e., Unix, NT, etc.) and easily deployed over the Internet, but other programming languages may also be used.

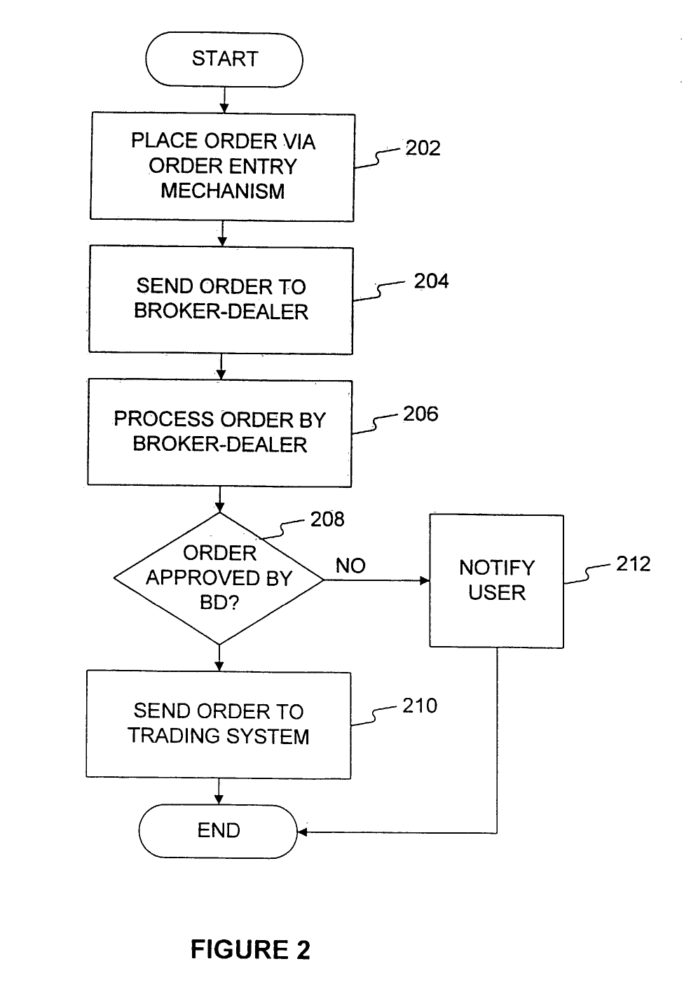

FIG. 2 illustrates a flowchart of the steps of a method for placing a trade order in the trading system in accordance with the present invention. Generally, a user 10 enters a trade order through the order entry mechanism 12 that is, in one implementation, supplied by the broker-dealer 18 (step 202). The order entry mechanism 12 may be an applet containing screens used to interface with the broker-dealer 18. The user 10 may make decisions on various trades based on information from the market information mechanism 14, which will be described below.

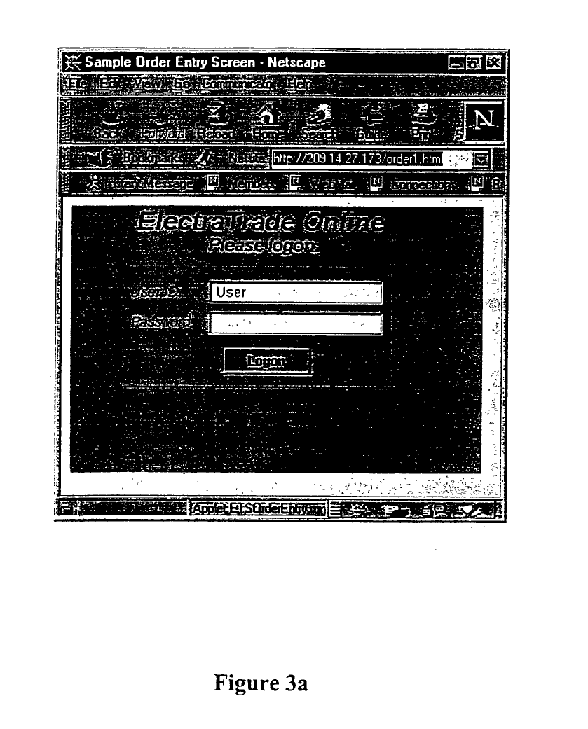

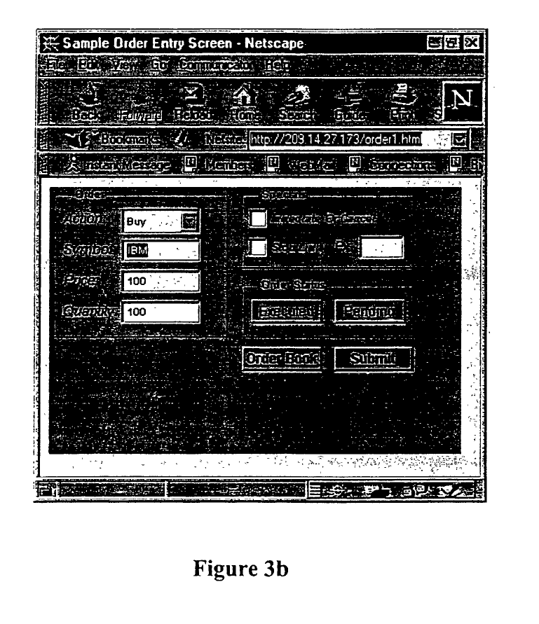

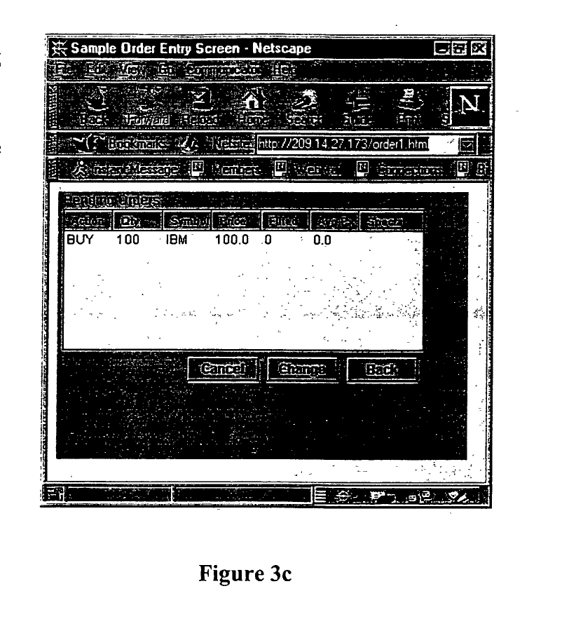

FIG. 3A illustrates an exemplary broker-dealer's initial order entry screen in the order entry mechanism 12. Shown on the screen is a user identification and a password log on. The screens supplied to the user 10 in the order entry mechanism 12 may be the standard screens currently given to the user by a broker-dealer 18 with online capabilities, and they may vary greatly from the ones shown in the drawings.

FIG. 3B shows the next exemplary screen contained in the order entry mechanism 12 given to the user 10. On this screen, the user 10 may decide whether to buy or sell an amount of a certain type of stock at a specific price. For example, the screen in FIG. 3B shows a user 10 placing an order to buy 100 shares of IBM stock at one hundred dollars per share.

FIG. 3C depicts the following exemplary screen contained in the order entry mechanism 12. This screen displays pending open orders for the exemplary user 10. As shown on the figure, the screen shows a user 10 placing an exemplary buy order for 100 shares of IBM stock at 100 shares, and it shows that the buy order has not yet been filled.

Referring back to FIG. 1 and FIG. 2, information entered by the user 10 to the order entry mechanism 12 travels to the broker-dealer 18 via a network 16 such as the Internet (step 204). This network 16 facilitates the transferring of order entry information to and from the user 10 by the broker-dealer 18. As discussed below, it also facilitates the publication of the real-time market information to the user 10 from the trading system 28.

In one system consistent with the present invention, when the user 10 communicates across the network 16 with the broker-dealer 18, it does so via the broker-dealer web server 20.

The broker-dealer web server 20 is the broker web site which, in one implementation, hosts the order entry mechanism 12, which user 10 utilizes to enter trade orders. Once a trade order is entered, it is then relayed from the broker-dealer web server 20 to order processing 22 on the broker-dealer 18.

Order processing 22 is a “black box” representation of a broker dealer's back-end system and performs order verification, updates account positions (i.e., cash and securities), updates buying power, etc. Before the trade order is routed for execution (to the principal market exchanges or to the trading system 28 described below), order processing 22 verifies the order to make sure the user's account has the cash, securities or buying power to make the transaction (step 206). If approved (step 208), order processing 22 routes the trade order to the trading system interface 24, which is a software component that forwards the order information to the trading system 28 across a private network 26 (step 210). If the trade order is not approved by the BD 18, the BD notifies the user 10 (step 212).

In one implementation consistent with the present invention, the private network 26 is a private leased line network for security and performance advantages. Private leased lines are essentially telephone lines that are leased from a phone company for exclusive use. They are secure because only one system uses the lines, and they offer better performance because the system does not share bandwidth with other systems or businesses. Although the private network 26 realizes some advantages, a public network may also be used.

The trading system interface 24 represents the order approving mechanism by which orders are translated and transmitted from the broker-dealer 18 to the trading system's broker-dealer interface 30. The trading system interface 24 receives order confirmation and execution information from the broker-dealer interface 30 after the order has been processed by the trading system 28. After execution on the trading system 28 (described below), the order execution information is relayed back to the trading system interface 24 and then to order processing 22. The order execution information received from the trading system 28 is used to update the account position and buying power in the account by the broker-dealer 18.

When a broker-dealer 18 routes orders and communicates with the trading system 28, it preferably communicates using the Financial Information Exchange protocol (“FIX”), a protocol developed by the securities industry to standardize communications between brokerage firms. Alternatively, the broker-dealers 18 and the trading system 28 may use other communication protocols.

The configuration and implementation of order processing 22 may vary widely among broker-dealers 18. Most notably, numerous broker-dealer 18 firms outsource order processing 22 to third party broker-dealers called “clearing firms” which perform order processing 22 and other back-office functions for multiple client broker-dealers firms. In this case, as indicated in FIG. 1, the link between the trading system 28 and the broker-dealer 18 (which, as shown on FIG. 1, is comprised of the trading system interface 24, private network 26, and BD Interface 30) is through the clearing firm.

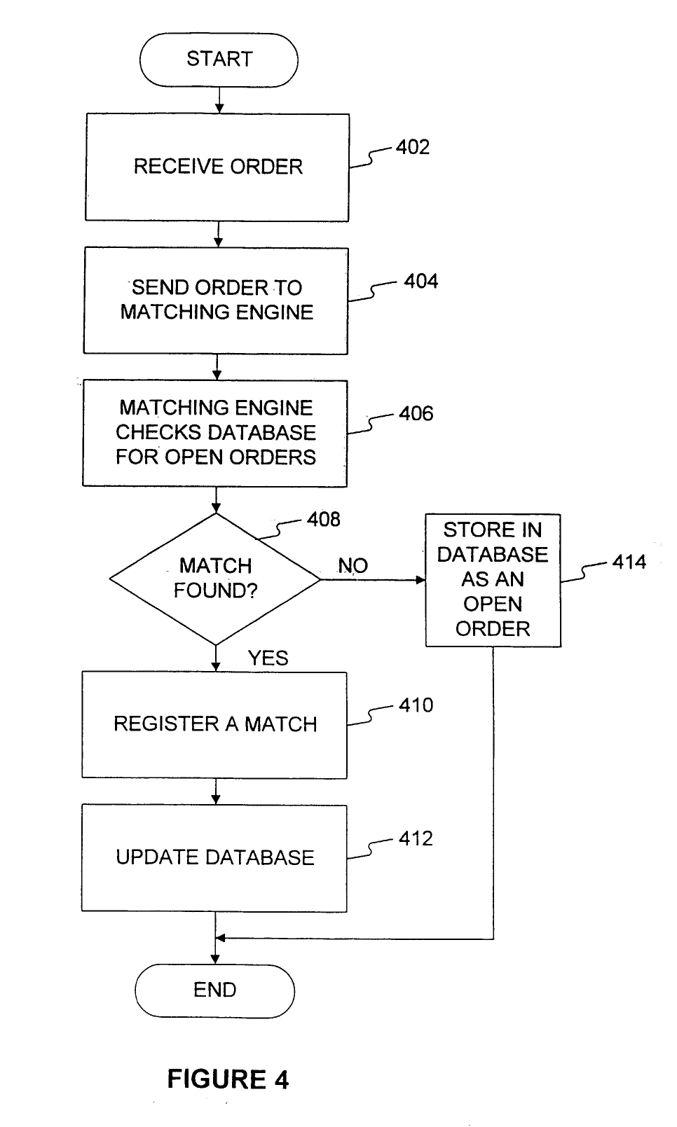

FIG. 4 illustrates the steps of a method for matching a trade order in the trading system in accordance with the present invention. The BD interface 30 on the trading system 28 is the component which receives orders from the BD 18 and sends confirmation/execution information back to the BD (step 402). It translates communications to the trading system 28 application programming interface (API), a formal set of specifications for one program to communicate with another program, which it uses to communicate with the matching engine 32 (step 404).

The matching engine 32 is the software component of the trading system 28 which actually performs order matches and executions. In one implementation consistent with the present invention, all of the matching logic (including anti-manipulation and other defensive schemes) is contained in the matching engine 32. When the matching engine 32 receives trade orders, it checks the database 34 for open orders to be matched (step 406), determines if a match is made (step 408) and updates the database 34 accordingly. For example, if one user 10 has placed an order to sell a certain number of shares of a specific stock, and another user 10 has placed an order to buy a certain number of shares of the same stock, and their prices match, the matching logic in the matching engine 32 registers a match (step 410). The matching engine 32 determines how many shares of that stock will change possession from the seller to the buyer.

Generally, orders that cross the market will result in execution at the best counterpart price currently offered on the trading system 28. If a user does not wish to buy as many shares as a seller is offering, partial order matches may be executed and the remaining quantity of the larger order may remain open and post back to the trading system 28 to be matched. If a match is determined between two trade orders, the matching engine 32 executes the order immediately and relays the order execution information to the database 34 for persistent storage (step 412). If the matching engine 32 does not find a matching open order for the received trade order, the trade order is stored in the database 34 as an open order to be matched with future trade orders (step 414).

The database 34 is the central repository for information in the trading system 28, including open orders, execution information, and audit trails. In one implementation consistent with the present invention, the database server 34 is an object-oriented database, although other types of databases may also be used. The database 34 on the trading system 28 stores the order information used by the matching engine 32 to determine a match. In doing so, it stores data relating to open orders and executed orders, in addition to other relevant data for the trading system 28.

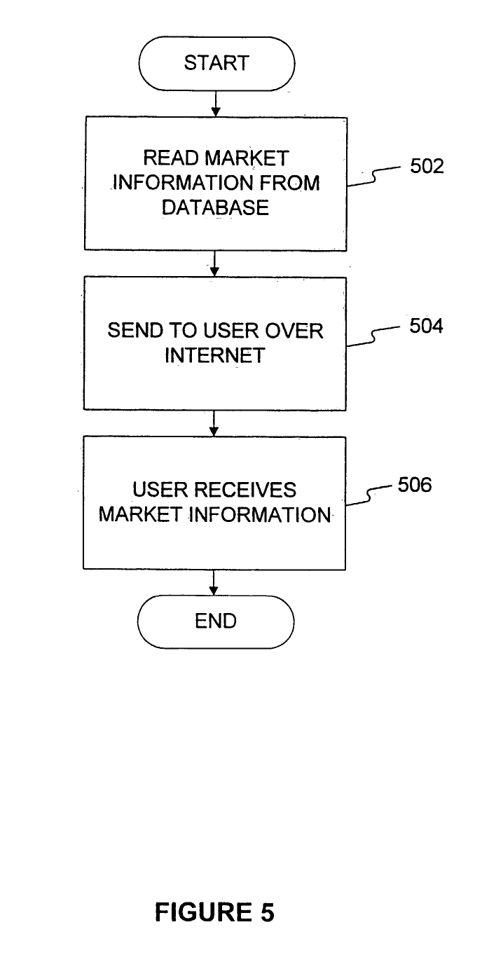

FIG. 5 depicts the steps of the method for publishing the trading system market information over a network, such as the Internet, in accordance with the present invention.

While receiving and executing trade orders, the trading system 28 may also publish its market information in real-time over a network such as the Internet 16. The Read-Only Applet Server 36 on the trading system 28 reads market information to be displayed over the Internet 16. It receives the market information from the database 34 (step 502) and relays it to the user 10 via the trading system web server 38, which is the trading system web site that sends the market information over the Internet (step 504). The trading system web server 38 hosts the market information mechanism 14, utilizing data from the Read-Only Applet Server 36. This market information mechanism 14 may contain an applet, referred to as an “order book,” showing open orders in the trading system 28 to the user 10 (step 506).

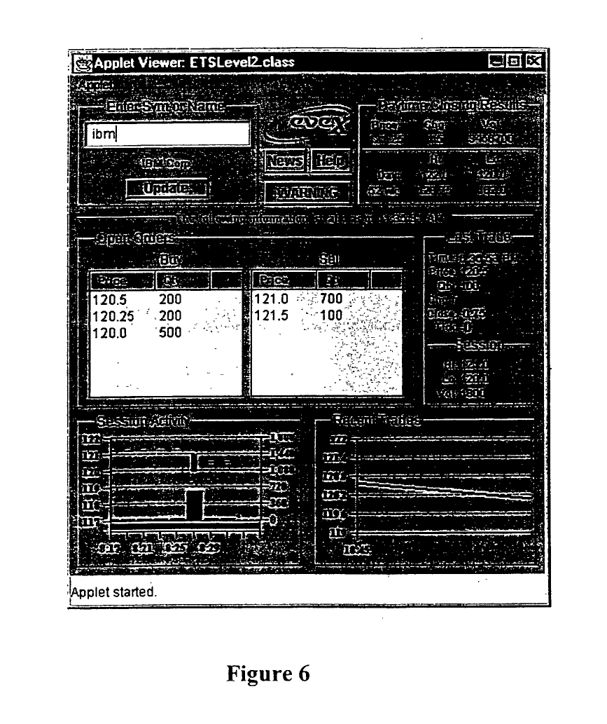

FIG. 6 illustrates an exemplary order book in accordance with the present invention.

The order book provides real-time quotations of all open trade orders on the trading system 28, grouped by security and listed by price and time of entry, for example. Besides enabling users 10 of the trading system 28 to identify and follow their own orders on the trading system, the order book may also display additional information such as a stock's closing price for the day on the principal market including price, volume, high and low prices, and the price change for the day. It may also display the last price at which a stock was executed on the trading system 28 and the quantity and time of the trade. Additionally, the order book may give other information such as the price change from the closing price for the day on the principal markets, the chart of prices and times of all executions in that stock during the session, and session high, low and volume information for the stock.

Some implementations consistent with the present invention may further display additional information to keep the users 10 informed. This information may include a list of the most active stocks during a particular session, indications of price swings of more than a particular percentage (e.g., 10 percent), from the stocks closing price during a session.

Furthermore, the order book may publish information regarding the types of orders that can be entered, in addition to real-time, after-hours news for use by all participating users 10 on the trading system 28 and the general public.

The foregoing description of an implementation of the present invention has been presented for purposes of illustration and description. It is not exhaustive and does not limit the present invention to the precise form disclosed. Modifications and variations are possible in light of the above teaching or may be acquired from practicing of the present invention. The scope of the present invention is defined by the claims and their equivalents.

What is claimed is:

1. An automated method for trading stocks, the method comprising:
receiving a first trade order from a first non-institutional user outside of exchange trading hours;
receiving a second trade order from a second non-institutional user outside of exchange trading hours;
comparing the first trade order with the second trade order; and
executing a trade in real-time between the first and second users when a match is determined between the first trade order and the second trade order.

2. The method of claim 1, wherein comparing includes
determining that the first trade order is a buy order for a number of shares of a specific stock at a specific price, and wherein the second trade order is a sell order for a number of shares of the same stock at the same price.

3. The method of claim 1, wherein receiving a first trade order from a first user includes:
receiving the first trade order from the first user via a broker-dealer.

4. The method of claim 1, wherein matching the first trade order further includes:
storing the first trade order in a database as an open order to be matched later if a match is not immediately determined.

5. The method of claim 1, wherein receiving a first order includes:
receiving the first trade order via the Internet, and
wherein receiving a second trade order includes receiving the second trade order via the Internet.

6. The method of claim 1, wherein executing a trade further includes:
updating a database if a trade between the first and second users is executed.

7. The method of claim 1, wherein executing a trade further includes:
notifying the first and second users of the executed trade.

8. The method of claim 7, wherein notifying the first and second users includes:
notifying the first and second users of the executed trade via the Internet.

9. An automated method for publishing real-time stock trading information from a computerized stock trading system, the stock trading information including open trade order information regarding open trade orders that have not been matched in the trading system, the method comprising:
accessing a trading system database to retrieve the open trade order information of trades placed by non-institutional users to be executed in real-time outside of exchange trading hours;
retrieving the open trade order information from the trading system database; and
sending the open order information over the Internet to a user.

10. The method of claim 9, wherein sending the open order information includes:
sending the open order information over the Internet to multiple users.

11. The method of claim 9, wherein sending the open order information includes:
sending the open order information to an Internet web site.

12. The method of claim 9, wherein sending the open order information further includes:
receiving the open order information by the user.

13. The method of claim 9, wherein retrieving the open trade order information includes retrieving executed trade order information, and
wherein sending the open trade order information includes sending the executed trade order information.

14. The method of claim 9, wherein retrieving the open trade order information includes retrieving additional stock trading information, and
wherein sending the open trade order information includes sending the additional stock trading information.

15. An automated method for trading stocks comprising:
receiving a first trade order from a first broker-dealer outside of exchange trading hours, the broker-dealer having received the first trade order from a first non-institutional user connected to the broker-dealer;
receiving a second trade order from a second broker-dealer outside of exchange trading hours, the broker-dealer having received the second trade order from a second non-institutional user connected to the broker-dealer;
comparing the first trade order with the second trade order; and
executing a trade in real-time between the first and second users when a match is determined between the first trade order and the second trade order.

16. The method of claim 15, further including the step of sending the trade order to the first broker-dealer via the Internet.

17. An automated method for trading stocks comprising:
sending a first trade order from a first non-institutional user to a broker-dealer outside of exchange trading hours;
receiving the first trade order by the broker-dealer;
verifying, by the broker-dealer, an acceptable account status of the first user for the first trade order;
sending the first trade order from the broker-dealer to a matching engine over a network if the first user's trade order is accepted by the broker-dealer;
receiving the first trade order from the broker-dealer by the matching engine;
comparing, by the matching engine, the first trade order with a second trade order placed by a second non-institutional user outside of exchange trading hours; and
executing a trade between the first and second users in real-time if a match between the first and second trade orders is determined.

18. The method of claim 17, wherein the network is a private network, and wherein sending the first trade order from the broker-dealer to the matching engine further includes:
sending the trade order from the broker-dealer to the matching engine over a private network.

19. A method in a broker-dealer data-processing system for processing a user's trade order for trading stocks, the method comprising:
receiving a trade order outside of exchange trading hours from a non-institutional user having an account on the broker-dealer data-processing system;
verifying that the user's account satisfies the trade order; and
sending the trade order to a trading system to be matched and executed outside of exchange trading hours in real-time with a second non-institutional users' trade order stored by the trading system.

20. The method of claim 19, wherein sending the trade order further includes:
notifying the user of the sending of the trade order to the trading system.

21. The method of claim 19, wherein sending the trade order further includes:
receiving a notification of whether the trade order was matched from the trading system; and
notifying the user of whether the trade order was matched.

22. A computer-readable medium containing instructions for controlling a data processing system to perform a method for trading stocks, the method comprising:
receiving a first trade order from a first non-institutional user outside of exchange trading hours;
receiving a second trade order from a second non-institutional user outside of exchange trading hours;
comparing the first trade order with the second trade order; and
executing a trade in real-time between the first and second users when a match is determined between the first trade order and the second trade order.

23. The computer-readable medium of claim 22, wherein comparing includes
determining that the first trade order is a buy order for a number of shares of a specific stock at a specific price, and the sell order is for a number of shares of the same stock at the same price.

24. The computer-readable medium of claim 22, wherein receiving a first trade order from a first user includes:
receiving the first trade order from the first user via a broker-dealer.

25. The computer-readable medium of claim 22, wherein matching the first trade order further includes:
storing the first trade order in a database as an open order to be matched later if a match is not immediately determined.

26. The computer-readable medium of claim 22, wherein receiving a first trade order includes:
receiving the first trade order via the Internet, and
wherein receiving a second trade order includes receiving the second trade order via the Internet.

27. The computer-readable medium of claim 22, wherein executing a trade further includes:
updating a database if a trade between the first and second users is executed.

28. The computer-readable medium of claim 22, wherein executing a trade further includes:
notifying the first and second users of the executed trade.

29. The computer-readable medium of claim 28, wherein notifying the first and second users includes:
notifying the first and second users of the executed trade via the Internet.

30. A computer-readable medium containing instructions for controlling a data processing system to perform a method for publishing real-time stock trading information from a computerized stock trading system, the stock trading information including open trade order information regarding open trade orders that have not been matched in the trading system, the method comprising:
accessing a trading system database to retrieve the open trade order information of trades placed by non-institutional users to be executed in real-time outside of exchange trading hours;
retrieving the open trade order information from the trading system database; and
sending the open order information over the Internet to a user.

31. The computer-readable medium of claim 30, wherein sending the open order information includes:
sending the open order information over the Internet to multiple users.

32. The computer-readable medium of claim 30, wherein sending the open order information includes:
sending the open order information to an Internet web site.

33. The computer-readable medium of claim 30, wherein sending the open order information further includes:
receiving the open order information by the user.

34. The computer-readable medium of claim 30, wherein retrieving the open trade order information includes retrieving executed trade order information, and
wherein sending the open trade order information includes sending the executed trade order information.

35. The computer-readable medium of claim 30, wherein retrieving the open trade order information includes retrieving additional stock trading information, and
wherein sending the open trade order information includes sending the additional stock trading information.

36. A computer-readable medium containing instructions for controlling a data processing system to perform a method for trading stocks, the method comprising:
receiving a first trade order from a first broker-dealer outside of exchange trading hours, the broker-dealer having received the first trade order from a first non-institutional user connected to the broker-dealer;
receiving a second trade order from a second broker-dealer outside of exchange trading hours, the broker-dealer having received the second trade order from a second non-institutional user connected to the broker-dealer;
comparing the first trade order with the second trade order; and
executing a trade in real-time between the first and second users when a match is determined between the first trade order and the second trade order.

37. The computer-readable medium of claim 36, further including the step of sending the trade order to the first broker-dealer via the Internet.

38. A computer-readable medium containing instructions for controlling a broker-dealer data processing system to perform a method for processing a user's trade order for trading stocks, the method comprising:
receiving a trade order outside of exchange trading hours from a non-institution user having an account on the broker-dealer data-processing system;
verifying that the user's account satisfies the trade order; and
sending the trade order to a trading system to be matched and executed outside of exchange trading hours in real-time with a second non-institutional users' trade order stored by the trading system.

39. The computer-readable medium of claim 38, wherein sending the trade order further includes:
notifying the user of the sending of the trade order to the trading system.

40. The computer-readable medium of claim 38, wherein sending the trade order further includes:
receiving notification of whether the trade order was matched from the trading system; and
notifying the user of whether the trade order was matched.

41. A data processing system for trading stocks comprising:
a receiving component configured to receive trade orders from non-institutional users outside of exchange trading hours;
a matching engine configured to match trade orders received from non-institutional users and execute trades outside of exchange trading hours in real-time between matching trade orders; and
a database configured to store trade orders.

42. The system of claim 41, further including:
a transmitting component configured to transmit real-time trading information outside of exchange trading hours to non-institutional users from the database.

43. The system of claim 42, wherein the transmitting component is a web server, and wherein the trading information is transmitted over the Internet.

44. The system of claim 41, wherein the database includes a section to store execution information.

45. The system of claim 41, wherein the receiving component is configured to receive the trade orders from broker-dealers outside of exchange trading hours.

46. A data processing system for publishing real-time stock trading information from a computerized stock trading system, the stock trading information including open trade order information regarding open trade orders that have not been matched in the trading system, the data processing system comprising:
a database configured to store open trade orders placed by non-institutional users outside of exchange trading hours that have not been matched and executed;
an accessing component configured to access the open trade order information in the database; and
a transmitting component configured to transmit the open trade order information outside of exchange trading hours in real-time to non-institutional users over the Internet.

47. A system for processing a user's trade order for trading stocks, the system comprising:
a receiving component configured to receive a trade order outside of exchange trading hours from a non-institutional user;
a database configured to store an account registered to the user;
a verifying component configured to verify that the user's account satisfies the trade order; and
a sending component configured to send the trade order to a trading system to be matched with a second non-institutional users' trade order and executed in real-time.

48. A data processing system for trading stocks comprising:
a receiving component configured to receive trade orders from multiple broker-dealers outside of exchange trading hours, the broker-dealers receiving the trade orders from non-institutional users connected to the broker-dealers;
a matching engine configured to match the received trade orders and execute trades between matching trade orders in real-time; and
a database configured to store trade orders that have not been matched.

49. A data processing system for trading stocks comprising:
means for receiving a first trade order from a first non-institutional user outside of exchange trading hours;
means for receiving a second trade order from a second non-institutional user outside of exchange trading hours;
means for comparing the first trade order with the second trade order; and
means for executing a trade in real-time between the first and second users when a match is determined between the first trade order and the second trade order.
